(19) United States
(12) Patent Application Publication
(10) Pub. No.: US 2019/0258436 A1
(43) Pub. Date: Aug. 22, 2019

(54) INFORMATION PROCESSING APPARATUS, CONTROL METHOD OF INFORMATION PROCESSING APPARATUS, AND PROGRAM

(71) Applicant: CANON KABUSHIKI KAISHA, Tokyo (JP)

(72) Inventor: Kazuya Oyamatsu, Niigata-shi (JP)

(21) Appl. No.: 16/272,154

(22) Filed: Feb. 11, 2019

(30) Foreign Application Priority Data
Feb. 20, 2018 (JP) 2018-028020

(51) Int. Cl. G06F 3/12

(52) U.S. Cl. CPC G06F 3/1255; G06F 3/1231; G06F 3/1232; G06F 3/1205

(57) ABSTRACT

An information processing apparatus having an application and a printer driver comprising: storage configured to store data that configures the printer driver and indicates model-dependent information including first conflict information indicating a combination of print setting values that mutually conflict with each other, and second conflict information that is related to the first conflict information and includes a specific condition that is interpretable by the application; at least one memory that stores a set of instructions; and at least one processor that executes the instructions, the instructions, when executed, causing the information processing apparatus to perform operations comprising: performing an operation that determines whether or not a print setting to be used for printing drawing data output by the application corresponds to the first conflict information or the second conflict information based on the data indicating the model-dependent information of the printer driver by executing instructions corresponding to the application; and performing an operation that displays information urging the activation of the printer driver on a display unit of the information processing apparatus in accordance with the determination that the print setting corresponds to the first conflict information or the second conflict information.

### BACKGROUND OF THE INVENTION

### Field of the Invention

The present invention relates to an information processing apparatus, a control method of the information processing apparatus, and a program.

### Description of the Related Art

In Microsoft's OS (Operating System), a printer driver that operates with a new architecture referred to as a “V4 printer driver” has been introduced. The V4 printer driver is a model-dependent file referred to as “PPD (PostScript Printer Description)” or “GPD (Generic Printer Description)”, and represents a print setting function that can be used in each model.

The V4 printer driver has a function referred to as “prohibition”, in which print settings are controlled that cannot be executed simultaneously by a device. Print settings that cannot be executed simultaneously by a device, in other words, print settings that are prohibited from being set simultaneously, are described in the model-dependent file that serves as information about a combination of invalid print settings. Hereinafter, in the present specification, an invalid combination of functions is referred to as “prohibition”, and information about the invalid combination of functions described in the model-dependent file is referred to as “prohibition information”. If the invalid combination of functions described in the model-dependent file is obtained due to a user changing the print setting, the V4 printer driver forcibly changes the setting so as not to use a function having the lowest priority. In this way, a setting change process that cancels the invalid combination performed upon designation of the invalid combination of the print settings (prohibition) is referred to as a “prohibition process”.

In print settings, there are a print setting in which a change is enabled from an application (for example, a general print setting such as paper size and double-side printing) and a print setting in which a change is not enabled from the application due to the manufacturer's unique function. In a case where the user wants to change only the print setting in which the change is enabled by using the application, the print setting can be changed without opening an UI (User Interface) of the printer driver. However, if the print setting is changed at the application side without opening the UI of the printer driver, a printing result intended by the user may not be obtained because the prohibition process cannot be performed at the printer driver side. Japanese Patent Application Laid-Open Publication No. 2011-145954 discloses a technique that displays a screen that provides a notification to the user about the print setting of the prohibition, and makes the user perform a resetting operation of a function about contents of the print setting if a prohibition is detected in the V3 printer driver, which is a conventional architecture.

However, since the conventional technique is a technique assuming using the V3 driver having the conventional architecture, the technique cannot be realized by the V4 printer driver having a new architecture due to the architectural restriction. Additionally, there are some applications such as Microsoft Word that urge the activation of the UI of the driver if they determine that the prohibition process is necessary as a result for interpreting the prohibition information described in the model-dependent file of the printer driver. However, it is impossible for even these applications to interpret all the prohibition information described in the model-dependent file of the printer driver, and they can only interpret the prohibition information including a specific function.

### SUMMARY OF THE INVENTION

An aspect of the present invention is to provide an information processing apparatus that can determine the prohibition of print settings in an application with a highly accuracy.

An aspect of the present invention is an information processing apparatus having an application and a printer driver comprising: storage configured to store data that configures the printer driver and indicates model-dependent information including first conflict information indicating a combination of print setting values that mutually conflict with each other, and second conflict information that is related to the first conflict information and includes a specific condition that is interpretable by the application; at least one memory that stores a set of instructions; and at least one processor that executes the instructions, the instructions, when executed, causing the information processing apparatus to perform operations comprising: performing an operation that determines whether or not a print setting to be used for printing drawing data output by the application corresponds to the first conflict information or the second conflict information, based on the data indicating the model-dependent information of the printer driver, by executing instructions corresponding to the application; and performing an operation that displays information urging the activation of the printer driver on a display unit of the information processing apparatus in accordance with the determination that the print setting corresponds to the first conflict information or the second conflict information.

Further features of the present invention will be described from the following description of the example description with reference to the attached drawings.

### BRIEF DESCRIPTION OF THE DRAWINGS

FIG. 1 illustrates an example of a hardware configuration of an information processing apparatus.

FIG. 2 illustrates a print process that uses a V4 printer driver.

FIG. 3 is a flowchart of a print setting process.

FIG. 4 illustrates an example of a model-dependent file.

FIG. 5 illustrates an example of the model-dependent file.

FIGS. 6A to 6E illustrate an example of prohibition information.

FIGS. 7A and 7B illustrate an example of the prohibition information.

FIG. 8 illustrates an example of the prohibition information.

### DESCRIPTION OF THE EMBODIMENTS

Hereinafter, best modes for carrying out the present invention will be described with reference to the drawings. A description method of seven model-dependent files will be described for each use case, and each use case will be referred to as a first embodiment to a seventh embodiment. The first embodiment will be described as a basic embodiment and the second embodiment to the seventh embodiment will describe the differences from the first embodiment.

### First Embodiment

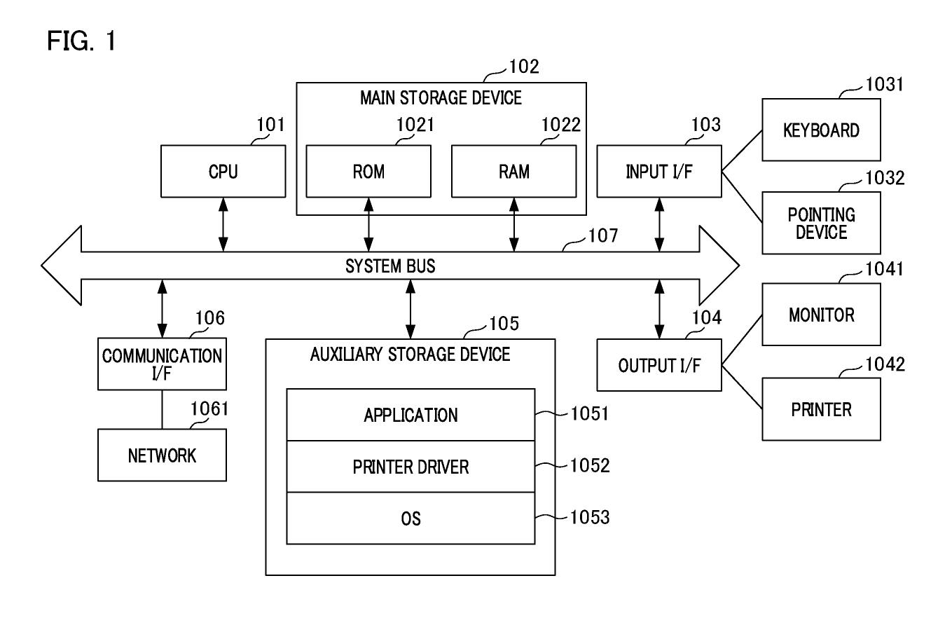

FIG. 1 is a block configuration diagram of a system using a general computer. The printing system has a CPU 101, a main storage device 102, an input I/F 103, an output I/F 104, an auxiliary storage device 105, and a communication I/F, which are connected via a system bus 107.

The CPU 101 controls the entire apparatus in accordance with a program stored in a ROM 1021 or a RAM 1022 of the main storage device 102, or the auxiliary storage device 105. The main storage device 102 includes the ROM 1021 and the RAM 1022. The ROM 1021 stores various programs. The RAM 1022 is a working memory performing various processes by the CPU 101 and temporarily stores various data. Processes for each component in the present embodiment are all read into the RAM 1022 and executed.

The auxiliary storage device 105 records, for example, an application 1051, a printer driver 1052, and an operating system (OS) 1053. The application 1051 is an application that can also perform print settings in Microsoft Word and Microsoft Excel and the like. The printer driver 1052 can provide a print instruction to a device having a printing function. The OS 1053 is, for example, an operating system such as Windows that controls the entire computer. Programs related to the application 1051, the printer driver 1052, and the OS 1053 are stored in the auxiliary storage device 105, loaded in the RAM 1022, and executed by the CPU 101. The application 1051 and the printer driver 1052 are operating on the OS 1053. The printer driver 1052 according to the present embodiment is a V4 printer driver.

The input I/F 103 is an interface that receives an instruction from the user to the computer via an input device such as a keyboard 1031 and a pointing device 1032 typified by, for example, a mouse/touch panel. The output I/F 104 is an interface for outputting data to the outside and outputs data to output devices such as a monitor 1041 and a printer 1042. The output I/F 104 and the printer 1042 may be connected not only by a local I/O directly but also connected via a communication I/F 106 and a network 1061. The communication I/F 106 is connected to the network 1061 and communicates with external devices. The network 1061 is, for example, a network such as a LAN (Local Area Network).

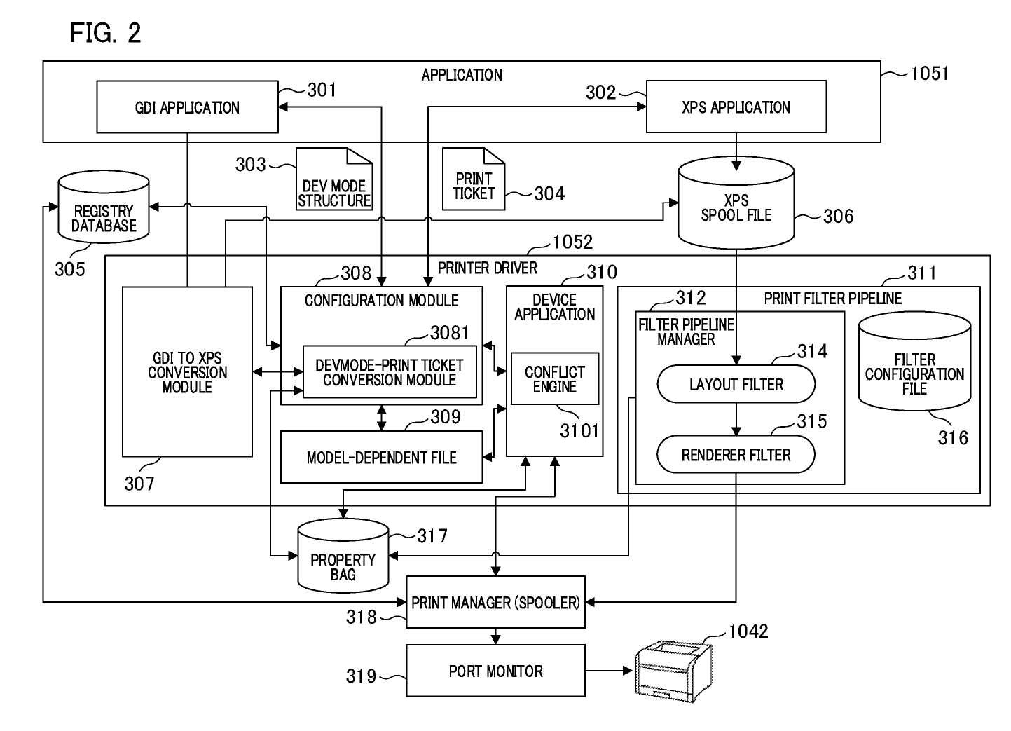

FIG. 2 illustrates a printing process using the V4 printer driver. The printer driver 1052 according to the present embodiment is a version 4 printer driver (V4 printer driver) operating on the Windows operating system. In the printing process using the V4 printer driver, printing is performed by using a file format referred to as an “XML Paper Specification (hereinafter, referred to as XPS)” as spool data. The driver printing system is operating on the OS 1053.

A print manager (spooler) 318, a port monitor 319, a GDI to XPS conversion module 307, and a filter pipeline manager 312 are modules included in the OS 1053. Among them, although the GDI to XPS conversion module 307 and the filter pipeline manager 312 are included in the printer driver 1052, they are positioned as modules dedicated to the printer driver 1052 provided from the OS 1053.

A GDI (Graphics Device Interface) is a graphics component that generates a print image of a printer. The GDI to XPS conversion module 307 has a function of converting data drawn by GDI into XPS data. The filter pipeline manager 312 is a module that manages a filter printing process that is a feature of the XPS printing pass. The port monitor 319 can control communication between the print manager 318 that accesses the device and the printer driver, and the printer driver performs a printing process via the port monitor 319.

The printer driver 1052 includes a layout filter 314 and a renderer filter 315 of the filter pipeline manager 312, and a device application 310. The device application 310 is installed in the information processing apparatus in conjunction with an installation process of the printer driver 1052 in the information processing apparatus.

The application 1051 includes a GDI printing application (hereinafter, referred to as a “GDI application”) 301 and an XPS printing application (hereinafter, referred to as an “XPS application”) 302. The GDI application 301 is an application that performs printing by using a GDI prepared by the OS 1053. The XPS application 302 is an application that performs printing by directly using an XPS spool file 306. The application 1051 is, for example, an application such as a word processor and spreadsheet software, and has the function of changing print settings from the application screen.

The user provides an instruction for a print process through the application 1051 displayed on the monitor 1041 of the output device by using an input device such as the keyboard 1031 and the pointing device 1032. This application 1051 refers to the GDI application 301 or the XPS application 302. The print process is realized by sequentially executing three processes, “selection of printer”, “generation of print setting data”, and “conversion of drawing data”. The flow of the printing process will be described below.

First, the printer 1042 to be used for printing is selected. The application 1051 selects the printer 1042 to be used for printing based on the user's operation through the screen of the application 1051. From the user's point of view, selecting the printer 1042 is synonymous with selecting the printer driver 1052 corresponding to the printer 1042 that executes printing. In order to select the printer driver 1052, for example, the name of the print queue is displayed on the screen of the application 1051.

Next, print setting data is generated. The print setting data is data including a setting value and the like of each function related to the printing process and the data is used for the print process. The print setting data includes, for example, setting values necessary for printing such as information about a size of paper to be output (for example, “A4”), designation of double-sided printing, color or black and white, and a paper feed tray. In generating the print setting data, the application 1051 secures a memory region for print setting data in the RAM 1022. Subsequently, the application 1051 generates print setting data via a configuration module 308 of the printer driver 1052, and stores the generated print setting data in the region secured in the RAM 1022.

In the GDI application 301, a binary DEVMODE structure 303 is used as print setting data. In the XPS application 302, a print ticket 304 described in markup language XML (eXtensive Markup Language) is used as print setting data. The DEVMODE structure 303 includes a standard region defined by the OS 1053 and an extension region uniquely defined by the printer driver 1052. The print ticket 304 is print setting data described in XML format. In the print ticket 304, the standard region and the extension region are separately described depending on the namespace. The application 1051 changes the print setting by rewriting the contents of the DEVMODE structure 303 or the print ticket 304.

If the print setting data is represented by the DEVMODE structure 303, the specification of the standard region of the print setting data has been disclosed outside. Accordingly, the GDI application 301 directly changes the contents of the standard region of the print setting data. Detailed specifications of the extended region that depends on the printer 1042 of the print setting data are grasped only by the printer driver 1052. Accordingly, the device application 310 changes the contents of the extended region of the print setting data, based on the user's operation via a user interface.

If the print setting data is represented by the print ticket 304, the setting value is described in the XML format, so the XPS application 302 can directly change all the setting values. However, since the extended region of the print setting data is uniquely defined for each printer driver 1052, the specification differs depending on the printer 1042, and the detailed specifications are not grasped by the XPS application 302. Therefore, the device application 310 changes a setting value of the extended region of the print setting data based on the user's operation via the user interface.

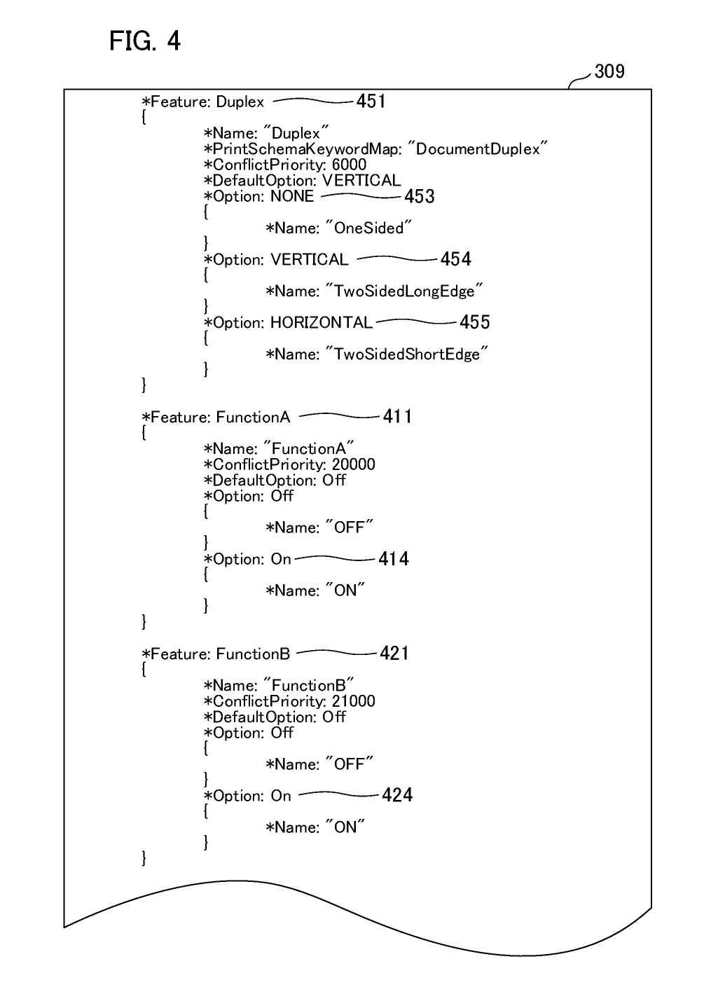

Since the print setting data also includes model-specific information, the configuration module 308 generates print setting data by using a model-dependent file 309. The model-dependent file 309 refers to a print setting definition file referred to as “GPD (Generic Printer Description)”, which defines information about the settings for each printer (machine type) (model-dependent information). The model-dependent file 309 is described on a text basis as shown in FIG. 4 to be described below. In the model-dependent file 309, it is possible to describe the setting values of each function included in the print setting data and information about invalid combinations of the setting values of each function included in the print setting data, in other words, “prohibition information”. The combination of the setting values described in the prohibition information is an invalid combination in which setting is prohibited. Specifically, the prohibition information is information indicating a combination of print setting values that conflict with each other (conflict condition). The combination of the setting values that are not described in the prohibition information is a permitted combination. If an invalid combination described in the model-dependent file 309 is obtained by changing the print setting by the user, the printer driver 1052 forcibly changes the setting so as not to use the function having the lowest priority in accordance with the defined prohibition. In this way, a process that determines whether or not the invalid combinations of the print settings are designated and a process that changes setting so as to cancel the invalid combinations performed upon designation of an invalid combination are referred to as a “prohibition process”. In this context, the invalid combination of the setting values of each function includes not only the one that cannot be provided as a function of the printer 1042 but also intentionally includes any item that is not desired to have the user use.

Although the device application 310 is included in the printer driver 1052, it is installed as a program different from the printer driver 1052. The device application 310 exchanges print setting data with the printer driver 1052 by using the DEVMODE structure 303 or the print ticket 304. The device application 310 includes a conflict engine 3101. If a setting value of an invalid combination of each function of the print setting data is set, the conflict engine 3101 generates print setting data in which the setting values of not invalid combination are set. Since the information about the invalid combinations of the setting values of each function included in the print setting data is described in the model-dependent file 309, the conflict engine 3101 reads the model-dependent file 309 before displaying the user interface. The printer driver 1052 changes the setting that depends on the printer 1042 shown by the DEVMODE structure 303 or the print ticket 304 based on the user's operation via the user interface. Since the print setting data is necessary for each print process, each time printing is executed, the application 1051 generates print setting data.

The printer driver 1052 stores, for example, an optional device of the printer 1042 and the environment setting for each user in a registry database 305 or a property bag 317 of the OS 1053. The print manager 318 of the OS 1053 stores a default value of the print setting data in the registry database 305. The registry database 305 and the property bag 317 are stored in the auxiliary storage device 105.

Finally, a conversion process of drawing data is performed. After the print setting data is determined, the application 1051 instructs the printer 1042 to perform the print process based on the user's operation via the user interface.

If the application 1051 provides instructions to perform the print process via the GDI application 301, the application 1051 transmits drawing data to the GDI to XPS conversion module 307. The GDI to XPS conversion module 307 generates the XPS spool file 306. In generating the XPS spool file 306, the GDI to XPS conversion module 307 invokes the configuration module 308 and converts the print setting data from the DEVMODE structure 303 into the print ticket 304. In converting the print setting data, the GDI to XPS conversion module 307 uses a DEVMODE-print ticket conversion module 3081. Since the DEVMODE-print ticket conversion module 3081 can read and write the information of the property bag 317, it can convert the print setting data by referring to the data stored by the device application 310.

There are two methods for generating the XPS spool file 306 in a case where the application 1051 provides an instruction to perform the print process via the XPS application 302. One is a method in which the XPS application 302 itself generates the XPS spool file 306. The other one is a method in which the OS 1053 generates an XPS spool file 306 in accordance with a drawing command from the XPS application 302.

In both cases in which the application 1051 provides instructions to perform the print process via the GDI application 301 and in which the application 1051 provides instructions to perform the print process via the XPS application 302, the XPS spool file 306 is generated during the processing of the print process. In this way, the print process using the printer driver 1052, which is the V4 printer driver, has a feature that the XPS spool file 306 based on the drawing data is always generated during printing.

The print process proceeds by transferring the XPS spool file 306 to the filter in a print filter pipeline 311, by performing a processing treatment to the XPS spool file 306 by each filter, and transferring the file to the subsequent filter. Eventually, the XPS spool file 306 is converted into a print job by each filtering process of the print filter pipeline 311 and transmitted to the printer 1042. The printer 1042 can interpret the print job and executes the print process based on the print job by interpreting the transmitted print job.

The print filter pipeline 311 acquires the generated XPS spool file 306 and executes the process for a plurality of filters. In the present embodiment, the print filter pipeline 311 performs a process of the layout filter 314 and the renderer filter 315. The number and types of filters included in the print filter pipeline 311 differs depending on the configuration of the printer driver 1052. For example, the print filter pipeline 311 may further include an encryption filter for encrypting a print job in addition to the two filters of the layout filter 314 and the renderer filter 315. Each filter in the print filter pipeline 311 can store its own data in the property bag 317. Additionally, each filter in the print filter pipeline 311 can also acquire information of the OS 1053 and data of another filter from the property bag 317.

A filter configuration file 316 controls the number of filters included in the print filter pipeline 311 and the order of filters that perform the process. The filter pipeline manager 312 causes the respective filters in the order of the layout filter 314 and the renderer filter 315 to execute the process in accordance with the filter configuration file 316.

The layout filter 314 performs a process related to layout such as change of magnification, imposition layout of bookbinding, stamping, and the like. The renderer filter 315 renders the input XPS spool file 306 and converts it into a page description language (hereinafter, referred to as “PDL (Page Description Language)”). Additionally, the renderer filter 315 converts the setting of the standard region of the print setting data of the print ticket 304 into a printer job language (hereinafter, referred to as “PJL (Printer Job Language)”). If a subsequent filter exists, the renderer filter 315 collects PDL and PJL as a print job and transfers it to a subsequent filter as stream data. If the subsequent filter does not exist, the renderer filter 315 transfers the converted PDL and PJL together as a print job to the filter pipeline manager 312.

The filter pipeline manager 312 transmits the transferred print job to the print manager 318 that manages a schedule of the print process. The print manager 318 sequentially registers the transmitted print jobs in a queue. The print manager 318 communicates with the printer 1042 and transmits the print jobs to the printer 1042 in the order of the registration of the print jobs in the queue via the port monitor 319 as soon as the printer 1042 becomes ready for printing.

As described above, the main role of the printer driver 1052 is to convert drawing data and print setting data into a print job. The information processing apparatus transmits the print job converted by the printer driver 1052 to the printer 1042 to provide instructions to perform the print process to the printer 1042.

Note that, in the present embodiment, the print process is used as an example and the process of the printer driver has been described. However, the process according to the present embodiment can also be applied to a FAX transmission process. In that case, the printer driver 1052 includes a FAX filter that generates FAX data instead of the renderer filter 315 and serves as a FAX driver that performs transmission to a FAX machine.

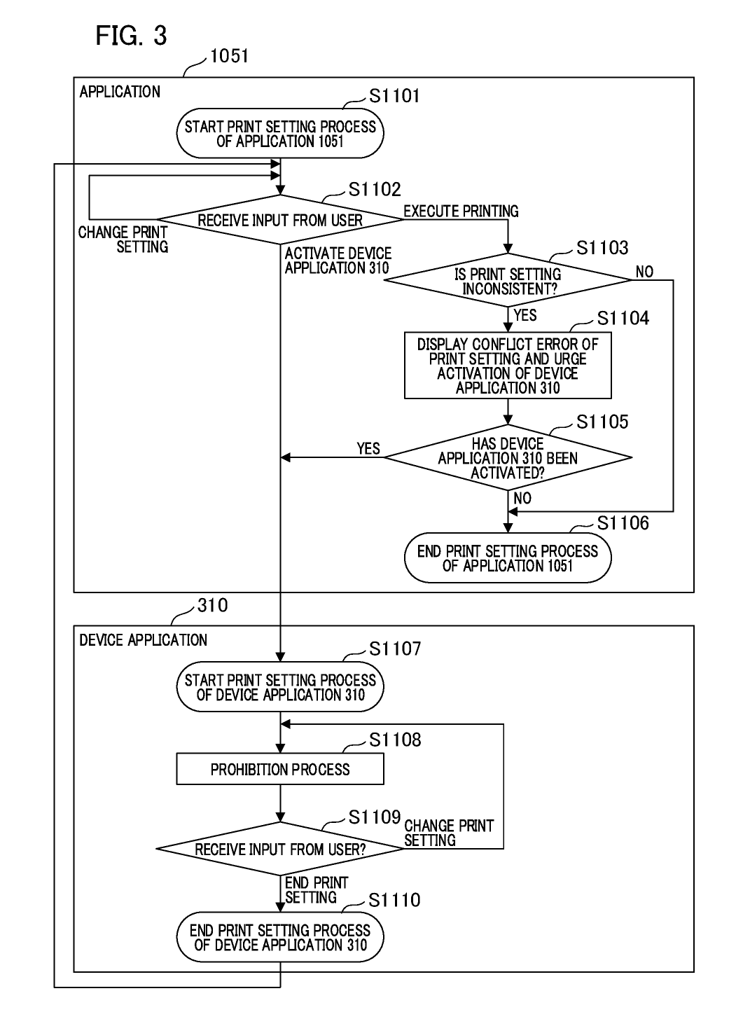

FIG. 3 is a flowchart of the print setting process. Programs of the application 1051 and the device application 310 pertaining to the print setting process are stored in the auxiliary storage device 105, read into the RAM 1022, and executed by the CPU 101. Additionally, in the present embodiment, Microsoft Word will be described as an example of the application 1051, which is one of the GDI applications 301.

First, in step S1101, the application 1051 displays a print setting screen on the monitor 1041 by the user's operation, and starts the print setting process. In step S1102, the application 1051 receives an input from the user on the print setting screen. If the user changes the print setting on the print setting screen, the process returns to step S1102. If the user activates the device application 310 on the print setting screen, the process proceeds to step S1107. If the user provides instructions to execute printing on the print setting screen, the process proceeds to step S1103.

In step S1103, the application 1051 determines whether or not the print setting is inconsistent. In the present embodiment, whether or not the print setting is inconsistent is determined based on whether or not the print setting corresponds to the prohibition information. If the print setting corresponds to the prohibition information described in the model-dependent file 309, it is determined that the print setting is inconsistent, and the process proceeds to step S1104. In contrast, if it is determined that the current print setting is not inconsistent, the process proceeds to step S1106, and the print setting process of the application 1051 ends.

As will be described in detail below, the prohibition information that can be determined by the application 1051 is limited to some pieces of prohibition information including a specific prohibition condition that is interpretable by the application 1051, among the prohibition information described in the model-dependent file 309. Accordingly, in a case where the print setting that corresponds to the prohibition information including the specific prohibition condition does not become inconsistent, the application 1051 cannot determine that print setting becomes inconsistent even if the print setting actually corresponds to the prohibition of the printer 1042. Specifically, even if the print setting that is currently set matches the prohibition information defined in the model-dependent file 309, there are cases in which, in step S1103, the determination that the print setting is inconsistent is not enabled, the device application 310 is not activated, and consequently, the prohibition process is not performed. Accordingly, in the present embodiment, the prohibition information that is not interpretable by the application 1051 is changed to a description that is interpretable so as to enable the determination that the print setting is inconsistent in step S1103. The determination that the print setting is inconsistent in step S1103 allows the device application 310 to perform the prohibition process.

In step S1104, the application 1051 displays an error screen on the monitor 1041. The error screen is, for example, a message indicating that the current print setting is a conflict error and a message urging the activation of the device application 310. In step S1105, the application 1051 receives an input from the user on the error screen. If the user activates the device application 310, the process proceeds to step S1107. In contrast, if the user does not activate the device application 310 and selects the execution of printing with inconsistent print settings, the print setting process of the application 1051 ends.

If the activation of the device application 310 is instructed from the user through the application 1051, the print setting process shifts from the application 1051 to the device application 310. In step S1107, the device application 310 starts the print setting process. In step S1108, the device application 310 performs a prohibition process of the print setting. By performing the prohibition process, it is possible to change to a print setting without inconsistency even if an inconsistent print setting is set.

In step S1109, the device application 310 receives an input from the user. If the user has changed the print setting, the process returns to step S1108 and the prohibition process is performed again. In contrast, if the user has ended the print setting without changing the print setting, the process proceeds to step S1110. In step S1110, the device application 310 ends the print setting process of the device application 310 and shifts to the print setting process of the application 1051.

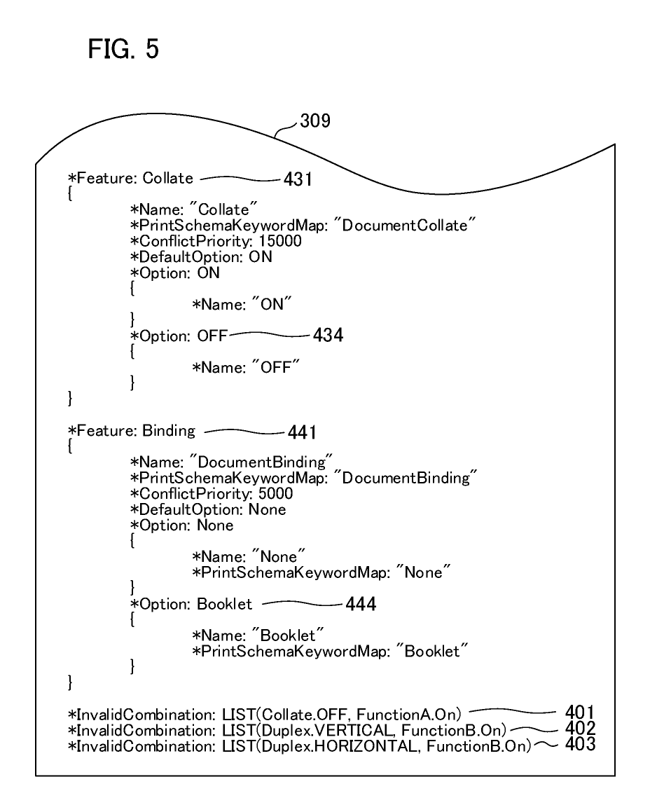

FIG. 4 and FIG. 5 illustrate an example of the model-dependent file 309. An example of a GPD, which is an example of the model-dependent file 309, is shown. The model-dependent file 309 includes a definition of the function included in the print setting data (Feature) and prohibition information. In the model-dependent file 309 in FIGS. 4 and 5, the function of double-side printing is defined in a function 451 (Duplex). Additionally, a function A and a function B are respectively appropriately applied to a function 411 (Function A) and a function 421 (Function B). Additionally, the function in each unit is defined to a function 431 (Collate), and a function of bookbinding printing is defined to a function 441 (Binding).

Each setting value candidate (option) is defined to each function defined in the model-dependent file 309, and a setting value of the function in the print setting data is determined by selecting one of the setting value candidates. For example, in the function 451 (Duplex), three options are defined as options for double-side printing. These three options are an option 453 (NONE) in which double-side printing is not performed, an option 454 (VERTICAL) in which double-side printing in long side binding is performed, and an option 455 (HORIZONTAL) in which double-side printing in short side binding is performed.

It is also possible to define a setting value candidate (default value, Default Option) set in the initial state to each function of the model-dependent file 309. In a state in which any operation is not performed after the image processing apparatus reads the model-dependent file 309, the setting value of each function in the print setting data becomes a default value. In the function 451 (Duplex), the option 454 (VERTICAL) in which double-side printing in long side binding is performed is defined as a default value.

A priority order (Conflict Priority) is set to each function defined in the model-dependent file 309. The smaller the numerical value of the function is, the higher the priority order of the function is. In contrast, the larger the numerical value of the function is, the lower the priority order of the function is. In the function 451 (Duplex), “6000” is set as a value of the priority order and, in the function 421 (Function B), “21000” is set as a value of the priority order. If the function 451 (Duplex) competes with the function 421 (Function B), the function 451 (Duplex) having a smaller value has a priority.

In the model-dependent file 309, the prohibition information is defined in addition to the definition of the function. The prohibition information is defined in the model-dependent file 309 as a list including a plurality of pairs of functions and setting value candidates (for example, the pair Duplex and VERTICAL). In the model-dependent file 309 shown in FIG. 5, prohibition information 401 to prohibition information 403 are defined. In the prohibition information 401, an option 434 of the function 431 and an option 414 of the function 411 are defined as an invalid combination. In prohibition information 402, the option 454 of the function 451 and an option 424 of the function 421 are defined as an invalid combination. In prohibition information 403, the option 455 of the function 451 and the option 424 of the function 421 are defined as an invalid combination.

If the combination of the setting values of the functions of the print setting data is the same as the combination described in the prohibition information, the combination is an invalid combination. Hereinafter, a pair of functions included in the prohibition information and setting value candidates (for example, Duplex. VERTICAL) is referred to as a prohibition condition. If the combination of the setting values set to each function of the print setting data is an invalid combination described in the prohibition information, the device application 310 performs a process that changes a setting value of the function having a lower priority order to a setting value having another default value. For example, if the option 454 of the function 451 and the option 424 of the function 421 described in the prohibition information 402 are set to the print setting data, the device application 310 changes the option of the function 421 having the lower priority order to a default value.

In step S1103, the application 1051 determines whether or not the print setting is inconsistent. In this case, the application 1051 determines that the print setting is inconsistent if the specific prohibition condition is included in the prohibition information. This is because, in Microsoft Word, which is an example of the application 1051, the prohibition information is interpretable at the application 1051 side due to the fact of “the specific prohibition condition is included in the prohibition information”. For example, “Duplex.VERTICAL” or “Duplex.HORIZONTAL” corresponds to the specific prohibition condition. Hence, the prohibition information 402 and the prohibition information 403 that include a specific prohibition condition in the prohibition information are interpretable at the application 1051 side, and the application 1051 determines that the print setting is inconsistent if the prohibition information matches the print setting. In contrast, since the prohibition information 401 that does not include a specific prohibition condition in the prohibition information is not interpretable at the application 1051 side, the application 1051 cannot determine that the print setting is inconsistent even if the prohibition information matches the print setting. Accordingly, in the present embodiment, the application 1051 is enabled to determine that a printing setting is inconsistent even in the prohibition information that does not include a specific prohibition condition.

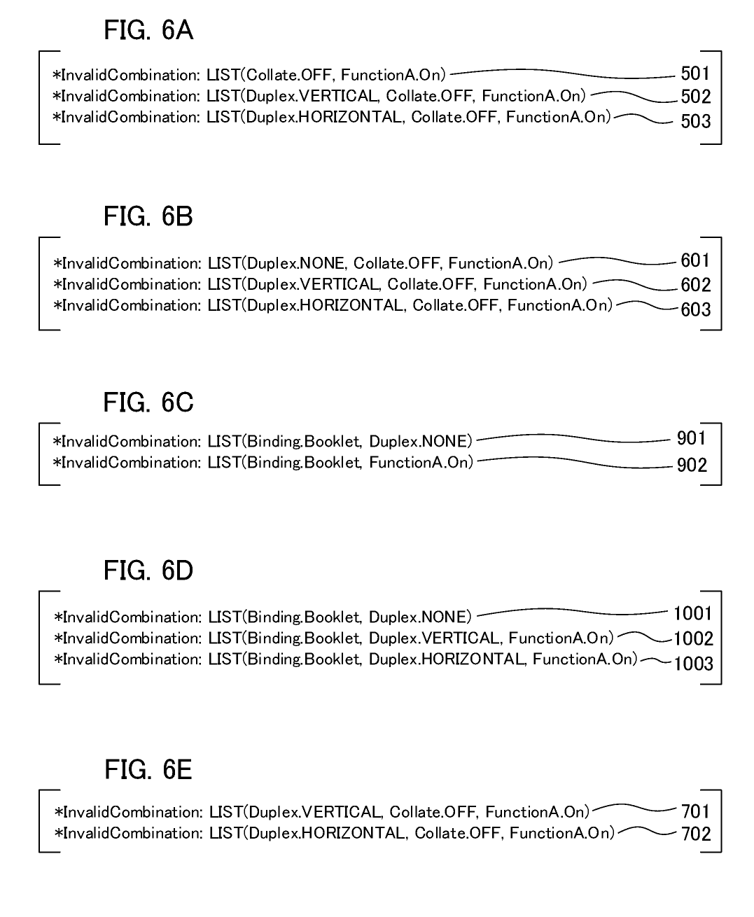

A method for causing the application 1051 to interpret the prohibition information 401 will be described with reference to FIG. 6A. FIG. 6A is an example of the prohibition information for explaining the first embodiment. Note that the model-dependent file 309 according to the first embodiment is a file in which the prohibition information 401 of the model-dependent file 309 in FIG. 5 is replaced by FIG. 6A.

First, in order to enable the application 1051 to interpret the prohibition information 401, a specific prohibition condition is added to the combination of the prohibition conditions of the prohibition information 401. Prohibition information 502 and prohibition information 503 are obtained by adding specific prohibition conditions to the prohibition information 401. “Duplex. VERTICAL” is added to the prohibition information 502, and “Duplex. HORIZONTAL” is added to the prohibition information 503. In the prohibition information 502 and the prohibition information 503, specific prohibition conditions for causing the application 1051 to interpret the prohibition information are included. Therefore, the print setting that matches the prohibition information 502 or the prohibition information 503 can be determined at the application 1051 side to be inconsistent printing setting.

Next, whether or not the added prohibition condition affects the prohibition process of the printer driver 1052 is checked. If the prohibition information 401 is replaced with the prohibition information 502 and the prohibition information 503, the meaning is different from the original prohibition information. In the prohibition information 401, the option 434 of the function 431 and the option 414 of the function 411 are always an invalid combination irrespective of the option of the function 451. However, if the prohibition information 401 is replaced with the prohibition information 502 and the prohibition information 503, the option 434 of the function 431 and the option 414 of the function 411 does not become an invalid combination even if the option 453 of the function 451 (Duplex. NONE) is set.

Accordingly, in order to prevent an influence on the prohibition process of the printer driver 1052 due to the replacement of the prohibition information 401, the prohibition information that is completely the identical to the original prohibition information 401 is added to the model-dependent file 309 as a prohibition information 501. Therefore, the prohibition information 401 is replaced by the prohibition information 501 to 503. The prohibition information 502 and the prohibition information 503 include all the prohibition conditions described in the prohibition information 501, and always match the prohibition information 501 in the case in which the print setting that matches the prohibition information 502 or the prohibition information 503. In the case of the print setting that matches the prohibition information 502 or the prohibition information 503, the prohibition information 501 having a few prohibition conditions is operated, and the prohibition information 502 or the prohibition information 503 is handled as invalid prohibition information. Hereinafter, the prohibition information that becomes meaningless due to the presence of another piece of prohibition information such as the prohibition information 502 and the prohibition information 503 is referred to as an “included prohibition”.

Although the included prohibition such as the prohibition information 502 and the prohibition information 503 has no meaning in the prohibition process, it is used in the application 1051 to determine whether or not the print setting is in a prohibition state. By replacing the original prohibition information 401 with the prohibition information 501 to 503, it is possible to cause the application 1051 to interpret the prohibition information 502 and the prohibition information 503 without changing the meaning of the prohibition information from the original prohibition information 401. Therefore, in step S1103, the print setting that has not been determined to be inconsistent in the illustration in FIGS. 4 and 5 is determined to be inconsistent by the illustration as shown in FIG. 6A. As a result, it is possible to prompt the activation of the device application 310 to perform the prohibition process by the device application 310. Additionally, the device application 310 can perform the process that is completely the same as before.

In the present embodiment, although Microsoft Word is used as an example of the application 1051, the present application is not limited thereto, and any application may be used if it can interpret the prohibition information of the model-dependent file 309. Additionally, in the present embodiment, although “Duplex. VERTICAL” and “Duplex. HORIZONTAL” are used as examples of the specific prohibition conditions, the present invention is not limited thereto, and any prohibition condition that can be interpreted by the application 1051 may be used. Additionally, there are several description methods defined by Microsoft as a defining method of the prohibition information. In the present embodiment, although the prohibition information is defined in a form in which “*Invalid Combination” is designated at the beginning of the line, another definition method (for example, a form in which “*Constraints” is designated at the beginning of the line) may be used.

As described above, according to the present embodiment, it is possible to determine the prohibition of the print setting at the application 1051 side with higher precision by adding a specific prohibition condition that is interpretable by the application 1051 to the prohibition information that is not interpretable by the application 1051.

### Second Embodiment

In the first embodiment, the prohibition information included in another prohibition (the prohibition information 502 and the prohibition information 503) is added to the model-dependent file 309. Although the description of the model-dependent file 309 depends on vendors, some of the vendors may not permit the description of the prohibition information included in another prohibition. If the description of the prohibition information included in another prohibition is not permitted, the first embodiment may not be applicable in some cases. Therefore, in the present embodiment, a method for causing the application 1051 to interpret the prohibition information 401, which is different from the first embodiment, will be described with reference to FIG. 6B. FIG. 6B is an example of the prohibition information for explaining the second embodiment. Note that the model-dependent file 309 according to the second embodiment is a file in which the prohibition information 401 of the model-dependent file 309 in FIG. 5 is replaced with FIG. 6B.

In the present embodiment, all the options of the function corresponding to the specific prohibition condition are added to the prohibition condition as prohibition information 601 to 603. Specifically, all the options of the function 451 (Duplex) corresponding to the specific prohibition condition “Duplex. VERTICAL” are added to the prohibition information 401. The prohibition information 601 is information to which the option 453 (None) is added, the prohibition information 602 is information to which the option 454 (VERTICAL) is added, and the prohibition information 603 is information to which the option 455 (HORIZONTAL) is added.

Thus, in the case where all the options of the function are added to the prohibition condition, whether or not the current print setting is an invalid combination is determined depending on whether or not the remaining prohibition condition matches the current print setting irrespective of a setting value of the corresponding function. That is, the prohibition information 601 to 603 has the same meaning as the original prohibition information 401. Therefore, in the present embodiment as well, it is possible to cause the application 1051 to interpret the prohibition information 602 and the prohibition information 603 without changing the meaning of the prohibition information from the original prohibition information 401.

As described above, in the present embodiment, all the setting values of the printing function of the specific prohibition condition that is interpretable by the application 1051 are added to the prohibition information that is not interpretable by the application 1051. Therefore, the prohibition of the print setting can be determined with higher accuracy at the application 1051 side.

### Third Embodiment

In the present embodiment, another model-dependent file 309 for adding a prohibition condition that is interpretable by the application 1051 will be described with reference to FIGS. 6C and 6D. FIG. 6C and FIG. 6D are examples of the prohibition information for explaining the third embodiment. First, it is assumed that prohibition information 901 and prohibition information 902 shown in FIG. 6C are described in the model-dependent file 309. In the prohibition information 901, an option 444 of the function 441 and the option 453 of the function 451 are defined as an invalid combination. In the prohibition information 902, the option 444 of the function 441 and the option 414 of the function 411 are defined as an invalid combination.

In the prohibition information 901, the matter that the function 441 has the option 444 is synonymous with that matter that the function 451 has the option 454 or the option 455. Accordingly, in the prohibition information 902, the combination is replaced with the combination of the option 444 of the function 441, the option 414 of the function 411, and the option 454 or the option 455 of the function 451. The example in which the prohibition information 902 is replaced in this way is a prohibition information 1002 and a prohibition information 1003 in FIG. 6D, and the example in which the prohibition information in FIG. 6C is replaced is the prohibition information in FIG. 6D. Since the prohibition information 1002 and the prohibition information 1003 in FIG. 6D include a condition that is interpretable by the application 1051, the prohibition process is enabled at the application 1051 side. As described above, in the present embodiment, the prohibition information 902 is limited based on the prohibition information 901 and is replaced with a condition that is interpretable by the application 1051, thereby enabling a prohibition process at the application 1051 side.

As described above, in the present embodiment, all of the specific prohibition conditions that are interpretable by the application 1051 are added to the prohibition information that is not interpretable by the application 1051. Therefore, it is possible to determine the prohibition of the print setting with higher accuracy at the application 1051 side.

### Fourth Embodiment

In the first to third embodiments, the prohibition information of the model-dependent file 309 is interpreted by the device application 310 through the conflict engine 3101. However, there are cases in which some printer drivers have their own prohibition information at the device application 310 side, without using the prohibition information of the model-dependent file 309. In the present embodiment, a case in which the prohibition process is performed with the prohibition information that is unique to the device application 310 will be described with reference to FIG. 6E. FIG. 6E is an example of the prohibition information for explaining the third embodiment. Note that the model-dependent file 309 in the third embodiment is a file in which the prohibition information 401 of the model-dependent file 309 in FIG. 5 is replaced with FIG. 6E.

In the present embodiment, since the prohibition information of the model-dependent file 309 is not used at the device application 310 side, it is possible to describe the prohibition information of the model-dependent file 309 only for the purpose of causing the application 1051 to perform the prohibition process. In the first embodiment to the third embodiment, it is necessary to add a prohibition condition so as not to change the meaning from the original prohibition information. However, in the present embodiment, it is not necessary to take into account the meaning of the original prohibition, only the prohibition information that is interpretable at the application 1051 side may be described. Accordingly, it is only necessary to replace the prohibition information 401 with prohibition information 701 and prohibition information 702 that include a specific prohibition condition that can be interpreted by the application 1051.

### Fifth Embodiment

The first to fourth embodiments are embodiments assuming that the printer driver 1052 supports “a function corresponding to a specific prohibition condition”. However, in some cases, the printer driver 1052 does not support “the function corresponding to a specific prohibition condition”. In the present embodiment, the model-dependent file 309 in the case where the printer driver 1052 does not support “the function corresponding to a specific prohibited condition” will be described.

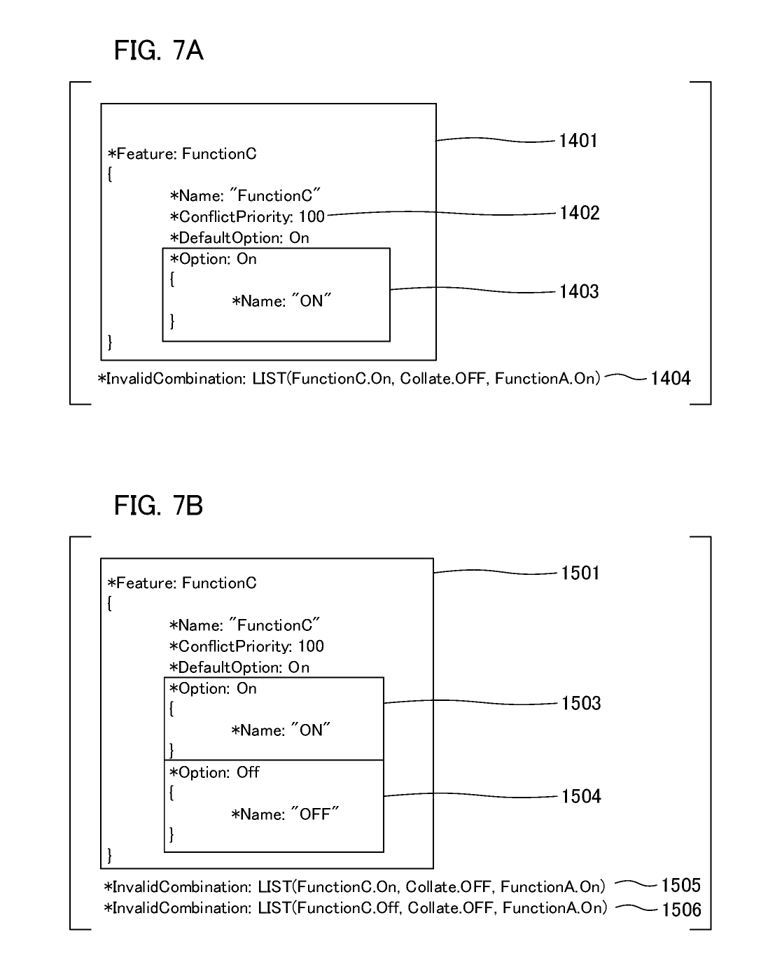

A specific prohibition condition in the present embodiment that is not supported by the printer driver 1052 though interpretable by the application 1051 is referred to as “Function C.On”. Additionally, a prohibition condition other than “FunctionC.On” (for example, FunctionC.Off) is assumed not to correspond to the specific prohibition condition. Assuming that the prohibition information to be interpreted by the application 1051 is the prohibition information 401 in FIG. 5, the prohibition information 401 is replaced with a prohibition information 1404 in FIG. 7A and a function 1401 is added to the model-dependent file 309.

FIG. 7A illustrates a part of the model-dependent file 309 according to the present embodiment. First, the function 1401 for determining prohibition, which serves as a condition for causing the application 1051 to interpret the prohibition information 401, is defined in the model-dependent file 309. An option 1403 supported by the function 1401 supports only an option that matches a specific prohibition condition that is interpretable by the application 1051. Therefore, the function 1401 has only one option (setting value). Additionally, since the function 1401 is only used for causing the application 1051 to interpret the prohibition information, the function 1401 should not be a target for the change of the options during the prohibition process. Therefore, a value that is smaller compared to other functions is set to Conflict Priority so that a priority 1402 of the function 1401 becomes higher compared to the other functions.

In order to allow the application 1051 to interpret the prohibition information, the option 1403 of the function 1401 is added to the combination of the prohibition information 401 to serve as the prohibition information 1404. Even if the printer driver 1052 does not support “a function corresponding to a specific prohibited condition”, the prohibition information can be confirmed by the application 1051 by describing the specific prohibition condition that is interpretable by the application 1051 in the model-dependent file 309. Note that, in the present embodiment, since the function 1401 exists only for the purpose of causing the application 1051 to interpret the prohibition information, it is preferable that the device application 310 does not display the function 1401 on the UI.

### Sixth Embodiment

A sixth embodiment is an embodiment in which FIG. 7A, which illustrates a part of the model-dependent file 309 of the fifth embodiment, is replaced with FIG. 7B. In the present embodiment, a description will be given of a method for selecting whether or not the prohibition process should be performed at the application 1051 side by disclosing a function for causing the application 1051 to interpret the prohibition information to the user and switching a setting value of the function by the user. In the present embodiment, a difference from the fifth embodiment will be described, and any part not described in particular is the same as in the fifth embodiment.

First, a function 1501 for prohibition determination, which serves as a condition for causing the application 1051 to interpret the prohibition information 401, is defined in the model-dependent file 309. The options of the function 1501 support both an option 1503 that is interpretable at the application 1051 side and an option 1504 that is uninterpretable at the application 1051 side. In the present embodiment, it is possible to select whether or not the prohibition process is to be performed at the application 1051 side by disclosing the function 1501 to the user and switching the two options of the function 1501 through the device application 310. That is, if the prohibition process is performed at the application 1051 side, the option 1503 that is interpretable at the application 1051 side is selected. In contrast, if the prohibition process is not performed at the application 1051 side, the option 1504 that is not interpretable at the application 1051 side is selected.

Prohibition information 1505 and prohibition information 1506 are the same prohibition information except that the option of the function 1501 is different. Additionally, the combination of the prohibition information 1505 and the prohibition information 1506 covers all the options of the function 1501. Consequently, the prohibition information 1505 and the prohibition information 1506 have the same meaning as the original prohibition information 401. This concept is the same as that described in the second embodiment. Therefore, the behavior of the prohibition process in the device application 310 is completely unchanged before and after the application of the present embodiment. In contrast, since the application 1051 cannot interpret the prohibition information 1506, the prohibition state is determined only if the print setting matches the prohibition information 1505, and the prohibition process is performed. This means that if the function 1501 is the option 1503, the prohibition process at the application 1051 side is performed, and if the function 1501 is the option 1504, the prohibition process is not performed by the application 1051. According to the present embodiment, the user can change the setting of the function 1501 through the device application 310 without affecting the prohibition process of the device application 310, and can select whether or not the prohibition information is to be interpreted at the application 1051 side.

### Seventh Embodiment

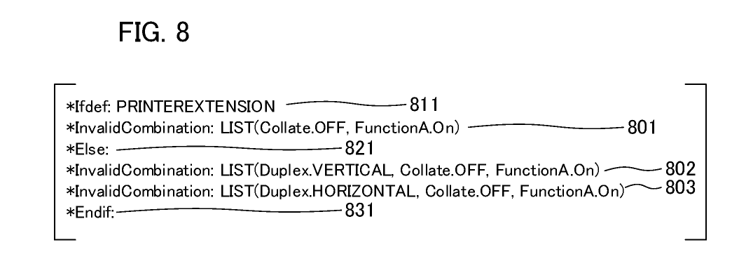

The prohibition information of the model-dependent file 309 proves that the too many items cause a phenomenon that the printer driver 1052 cannot be installed. Accordingly, the prohibition information of the model-dependent file 309 should not be increased more than necessary. Additionally, by the use of a preprocessor directive such as “*Define” and “*Ifdef”, the model dependent file 309 allows the description to be read by the application 1051 to be restricted. In the present embodiment, the prohibition information to be read by the application 1051 is reduced by using the preprocessor directive. In the seventh embodiment, FIG. 6A shows an example of the prohibition information according to the first embodiment is replaced with FIG. 8. Note that reducing the pieces of the prohibition information to be read by the application 1051 as described in the present embodiment can be applied to any of the first embodiment to the sixth embodiment. The way to use the preprocessor directive that is used in the description of the present embodiment is the same as that of general programming languages such as C language.

The model-dependent file 309 defines any character string as a symbol by “*Define”, but in the present embodiment, no symbol definition by “*Define” is performed. Accordingly, the character string “PRINTER EXTENSION” described in *Ifdef line 811 is not defined as a symbol. Hence, prohibition information 801 that is located between the *Ifdef line 811 and the *Else line 821 is not interpreted by the application 1051. In contrast, prohibition information 802 and prohibition information 803 that are located between *Else line 821 and *Endif line 831 are interpreted by the application 1051. Thus, the prohibition information that is interpretable by the application 1051 and prohibition information that is not interpretable by the application 1051 are described separately and the prohibition information that is not interpretable is not disclosed to the application 1051, so that it is possible to reduce the number of items of prohibition information to be read by the application 1051.

Additionally, in view of the device application 310 side, the prohibition information 802 and the prohibition information 803 are unnecessary pieces of information. Since the model-dependent file 309 can be freely interpreted at the device application 310 side, the device application 310 can also apply only the prohibition information 801 based on the information of the preprocessor directive by making a description as shown in FIG. 8. Thus, in the present embodiment, a prohibition process that is similar to that in the first embodiment can be performed while reducing the prohibition information to be interpreted by the application 1051 or the printer driver 1052. Additionally, in the present embodiment, although an example of the description by the preprocessor directive has been described, the present invention is not limited thereto. For example, it may be possible that the prohibition information that does not need to be interpreted by the application 1051 may be commented out and then the prohibition information that has been commented out is interpreted at the printer driver 1052 side.

### OTHER EMBODIMENTS

Embodiment(s) of the present invention can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2018-028020, filed Feb. 20, 2018, which is hereby incorporated by reference wherein in its entirety.

What is claimed is:

1. An information processing apparatus having an application and a printer driver comprising:
storage configured to store data that configures the printer driver and indicates model-dependent information including first conflict information indicating a combination of print setting values that mutually conflict with each other, and second conflict information that is related to the first conflict information and includes a specific condition that is interpretable by the application;
at least one memory that stores a set of instructions; and
at least one processor that executes the instructions, the instructions, when executed, causing the information processing apparatus to perform operations comprising:
performing an operation that determines whether or not print setting to be used for printing drawing data output by the application corresponds to the first conflict information or the second conflict information, based on the data indicating the model-dependent information of the printer driver, by executing instructions corresponding to the application; and
performing an operation that displays information urging the activation of the printer driver on a display unit of the information processing apparatus in accordance with the determination that the print setting corresponds to the first conflict information or the second conflict information.

2. The information processing apparatus according to claim 1 further perform operations comprising:
performing an operation that executes an instruction corresponding to the printer driver in accordance with the call of an instruction that invokes a print setting interface of the printer driver from the application and determines whether or not the print setting corresponds to the first conflict information; and
performing an operation that cancels a conflict by changing at least one of the print settings that conflict with each other if the print setting is determined to correspond to the first conflict information.

3. The information processing apparatus according to claim 1,
wherein the first conflict information includes at least information indicating a setting in which a first print setting value and a second print setting value conflict with each other and information indicating a setting in which a third print setting value and a fourth print setting value conflict with each other,
wherein the second conflict information includes at least information indicating a setting in which the first print setting value, the third print setting, and the fourth print setting value conflict with each other,
wherein the first print setting value is a setting value that is interpretable by the application, and the third print setting value and the fourth print setting value are setting values that are not interpretable by the application, and
wherein, upon determining whether or not the print setting corresponds to the first conflict information or the second conflict information, the application performs a determination related to conflict information that includes a setting value that is interpretable by the application included in the data while not performing a determination related to conflict information that includes only a setting value that is not interpretable by the application.

4. The information processing apparatus according to claim 1,
wherein the second conflict information is conflict information obtained by adding a specific conflict condition that is interpretable by the application to conflict information indicating a combination of print setting values that are not interpretable by the application, among the first conflict information.

5. The information processing apparatus according to claim 1,
wherein the second conflict information is conflict information obtained by adding all setting values that are interpretable by the application to conflict information that is not interpretable by the application, among the first conflict information.

6. The information processing apparatus according to claim 1,
wherein the first conflict information and the second conflict information included in the data indicating the model-dependent information are stored in association with information indicating a priority to be used for cancelling the conflict of each setting value, and
wherein a priority that does not become a target of a setting change for cancelling the conflict is associated with a setting value related to a specific condition that is interpretable by the application, which is included in the second conflict information.

7. The information processing apparatus according to claim 1,
wherein the printer driver is a version 4 printer driver that operates on the Windows operating system.

8. The information processing apparatus according to claim 1,
wherein the application is a word processor application or a spreadsheet application.

9. A control method of an information processing apparatus having an application and a printer driver,
wherein the printer driver has data that indicates model-dependent information including first conflict information indicating a combination of print setting values that mutually conflict with each other, and second conflict information that is related to the first conflict information and includes a specific condition that is interpretable by the application,
wherein the application determines whether or not a print setting to be associated with the print data to be output by the application corresponds to the first conflict information or the second conflict information based on the data indicating the model-dependent information of the printer driver, and
wherein the application performs control to display information that urges the activation of the printer driver on a display unit of the information processing apparatus in accordance with the determination by the application that the print setting corresponds to the first conflict information or the second conflict information.

10. A non-transitory computer-readable storage medium storing data configuring a printer driver and including conflict information indicating a combination of print setting values that conflict with each other, the data being read by a computer, referred to by an application executed on the computer, and used for the following control comprising:
determining whether or not a print setting to be used for printing drawing data output by the application corresponds to a conflict condition by the application, with reference to the data,
wherein, in accordance with the determination that the print setting corresponds to the conflict condition, the application displays information that urges the activation of the printer driver on a display unit of the computer, and
wherein the conflict information includes first conflict information indicating a combination of print setting values that conflict with each other and second conflict information that is related to the first conflict information and includes a specific condition that is interpretable by the application.
